(19) United States
(12) Patent Application Publication
(10) Pub. No.: US 2007/0019054 A1
(43) Pub. Date: Jan. 25, 2007

(54) Business machine

(75) Inventor: Ying-Qi Zhu, Jiangsu (CN)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/485,611

(22) Filed: Jul. 11, 2006

(30) Foreign Application Priority Data
Jul. 19, 2005 (TW) TW94124280

(51) Int. Cl. B41J 2/01

(52) U.S. Cl. 347/104

(57) ABSTRACT

A business machine. The business machine comprises a main body having a paper feed slot, an accommodating portion disposed around the paper feed slot and having a guide groove, and a tray loading paper and slidably joined with the guide groove to be positioned in a first position and a second position. When the tray is positioned in the first position, a predetermined angle is formed between the tray and the main body. When the tray is in a second position, the tray is parallel to the guide groove and accommodated in the accommodating portion.

### BACKGROUND

The invention relates to a business machine, and in particular to a business machine with a positionable paper tray.

FIGS. 1a and 1b depict a conventional business machine with a tray in use and idle respectively. The business machine 100 comprises a main body 10 and a tray 20 pivoted on a flange 14. When the tray 20 is used, the tray 20 is disposed on the feed slot 12 at an angle with respect to the main body 10 for loading paper as shown in FIG. 1a. When the tray 20 is idle, the tray 20 is rotated and laid on the main body 10 as shown in FIG. 1b.

In such a structure, however, the tray 20 is not fixed, either in use or idle, thus when the business machine 100 is moved, the tray 20 easily rotates potentially causing moving problems.

### SUMMARY

A business machine comprises a main body having a paper feed slot, an accommodating portion disposed around the paper feed slot having a guide groove, and a tray for loading paper slidably joined with the guide groove, and the tray can be positioned in a first position and a second position. When the tray is positioned in the first position, a predetermined angle is formed between the tray and the main body. When the tray is in a second position, the tray is parallel to the guide groove and accommodated in the accommodating portion.

The tray comprises a pivot mechanism slidably joined with the guide groove and positioned in the first and second positions by engaging the guide groove.

The pivot mechanism comprises a protrusion slidably engaging the guide groove having a depression. When the tray is positioned in the first position, the protrusion enters the depression to form the predetermined angle between the tray and the main body.

The pivot mechanism further comprises an elastic element joined with the protrusion and having a convex portion, and the guide groove has a first concave portion and a second concave portion. The tray is positioned in the first position when the convex portion engages the first concave portion and the tray is positioned in the second position when the convex portion engages the second concave portion. The elastic element is a spring plate which is substantially L-shaped with one end joining the protrusion and the other end having the convex portion. The protrusion projects in a direction perpendicular to the moving direction of the tray. The protrusion has a notch with which one end of the L-shaped spring plate engages.

The protrusion comprises a protrusion and an elastic portion having a convex portion, and the guide groove has a first concave portion and a second concave portion. The tray is positioned in the first position when the convex engages the first concave portion and is positioned in the second position when the convex portion engages the second concave portion. The elastic portion can be integrally formed with the protrusion. The protrusion can be integrally formed with the tray.

### BRIEF DESCRIPTION OF THE DRAWINGS

The invention can be more fully understood by reading the subsequent detailed description and examples with references made to the accompanying drawings, wherein:

FIGS. 1a and 1b depict a conventional business machine with a tray in use and idle;

FIGS. 2a and 2b depict an embodiment of a business machine with a tray in use and idle of the invention;

FIG. 3a depicts a guide groove of a business machine of the invention;

FIG. 3b is an enlarged view of region A of FIG. 3a;

FIG. 4a is perspective view of the tray of the invention;

FIG. 4b is an enlarged view of region B of FIG. 4a;

FIG. 4c is an exploded view of FIG. 4b;

FIGS. 5a to 5d depict steps of the tray from unused condition to working condition;

FIG. 5a-1 is an enlarged view of region C of FIG. 5a;

FIG. 5b-1 is an enlarged view of region D of FIG. 5b;

FIG. 5c-1 is an enlarged view of region E of FIG. 5c;

FIG. 5d-1 is an enlarged view of region F of FIG. 5d;

FIG. 6a is another embodiment of a pivot mechanism of the invention;

FIG. 6a-1 is a partially enlarged view of FIG. 6a;

FIG. 7a depicts a business machine with a sub-tray in working condition; and

FIG. 7b depicts a business machine with a sub-tray in an idle condition.

### DETAILED DESCRIPTION

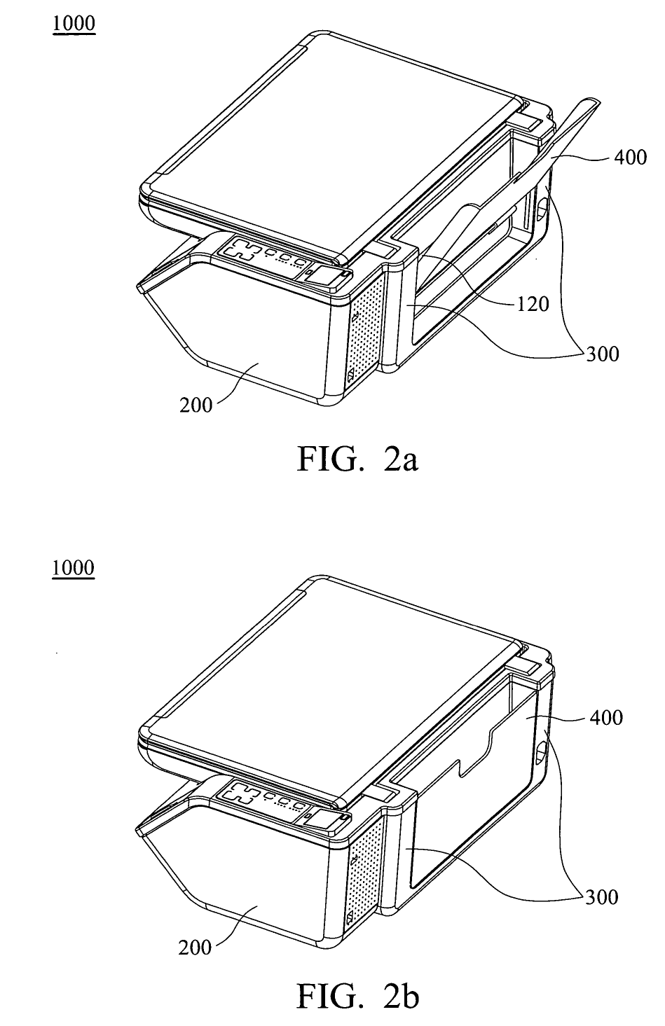

Referring to FIGS. 2a and 2b, an embodiment of a business machine comprises a main body 200, an accommodating portion 300 and a tray 400. The main body 200 comprises a paper feed slot 120 around which the accommodating portion 300 is disposed on the opposite sides of the paper feed slot 120. The tray 400 is pulled out of the accommodating portion 300 and positioned with an angle with respect to the main body 200 when the tray 400 is used. When the tray 400 is idle, it can be received in the accommodating portion 300.

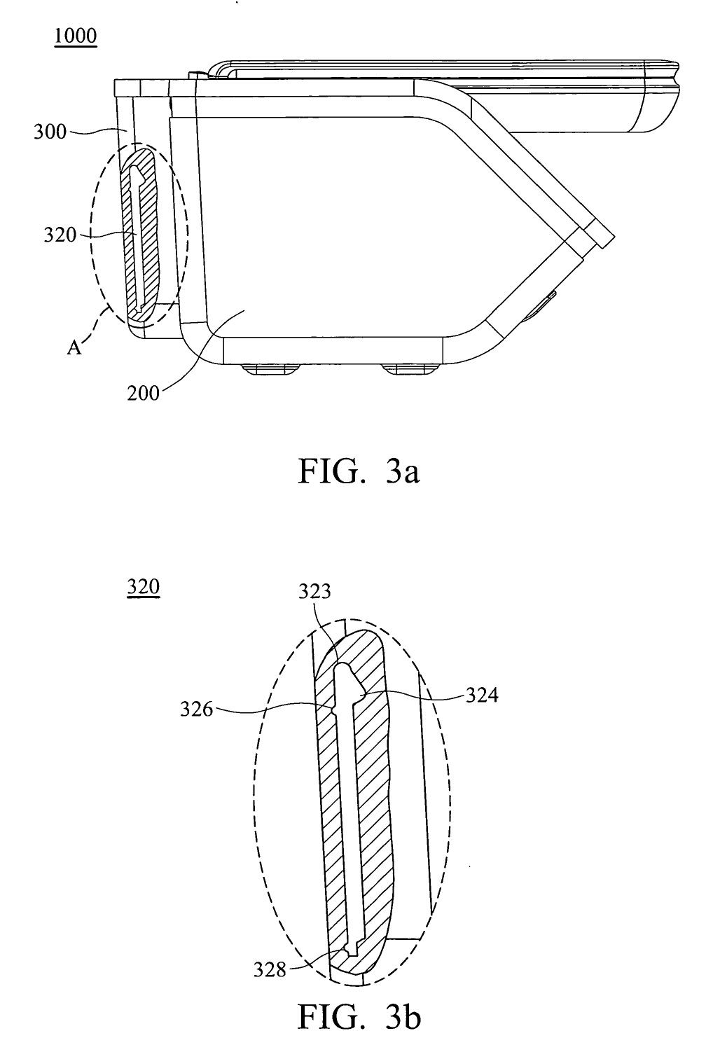

The accommodating portion 300 comprises a guide groove 320 with which the tray 400 slidably engages, whereby the tray 400 is easily pulled out to load paper as shown in FIG. 3a. Referring to FIG. 3b, the guide groove 320 comprises a arc portion 323, a depression 324, a first concave portion 326 and a second concave portion 328. The arc portion 323 is on the top of the guide groove 320, the first concave portion 326 and the second concave portion 328 are on the same side of the guide groove 320, and the depression 324 is formed on the side opposite to the first and second concave-portions 326 and 328.

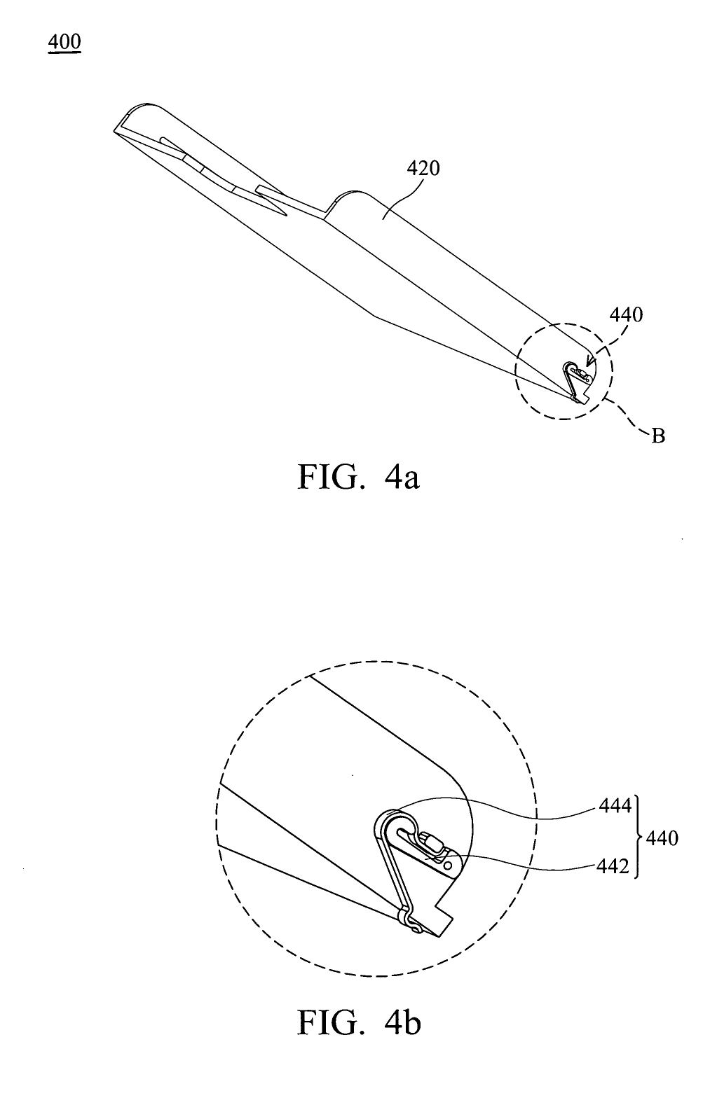

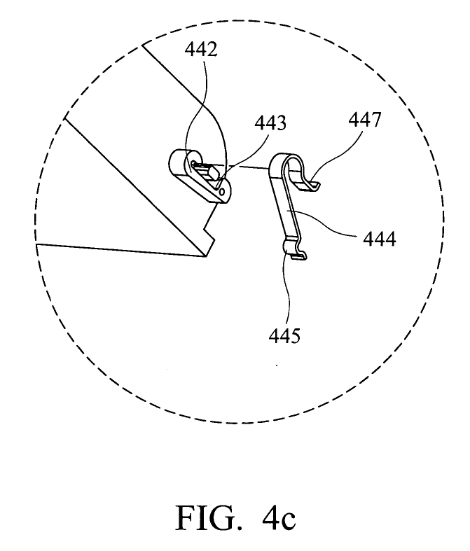

Referring to FIG. 4a, the tray 400 comprises a main body 420 loading paper and a pivot mechanism 440 disposed on one side of the main body 420 and slidably engaged with the guide groove 320. FIG. 4b is an enlarged view of region B of FIG. 4a. The pivot mechanism 440 comprises a protrusion 442 projecting from one side of the main body 420 and a spring plate (elastic element) 444 joined with the protrusion 442. FIG. 4c is an exploded view of the pivot mechanism 440. The protrusion 442 has a notch 443 engaging the spring plate 444. The spring plate 444 is substantially L-shaped with one end curved to form an engaging portion 447 and the other end formed a convex portion 445.

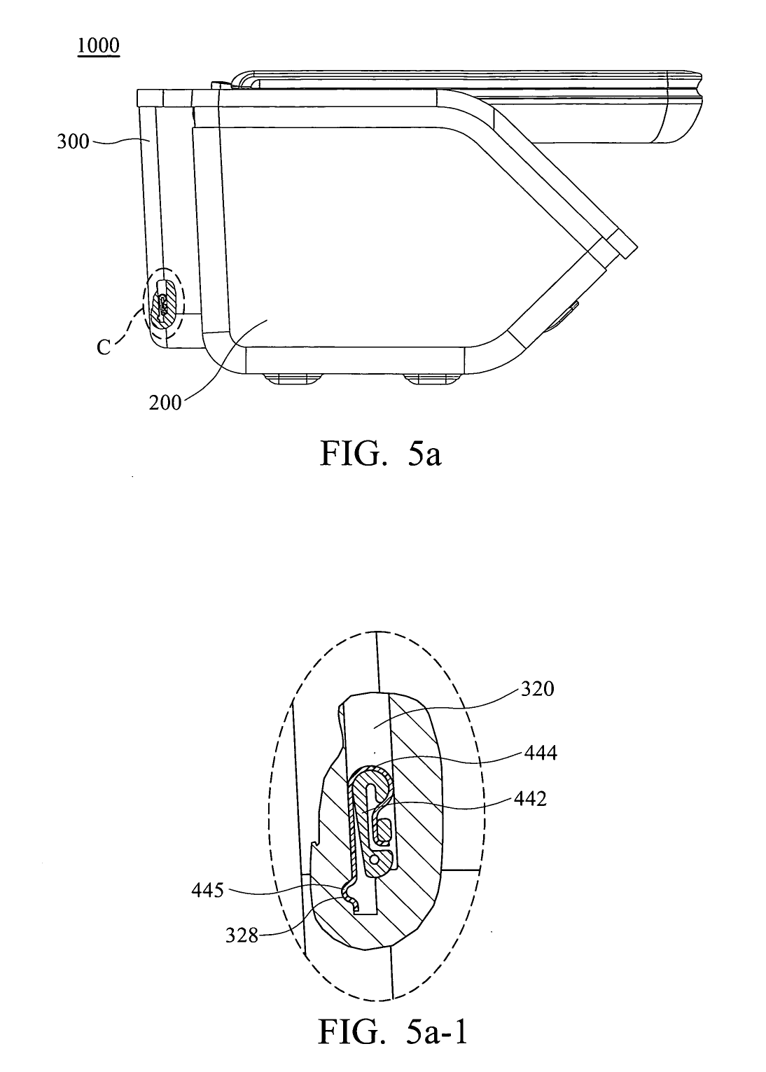

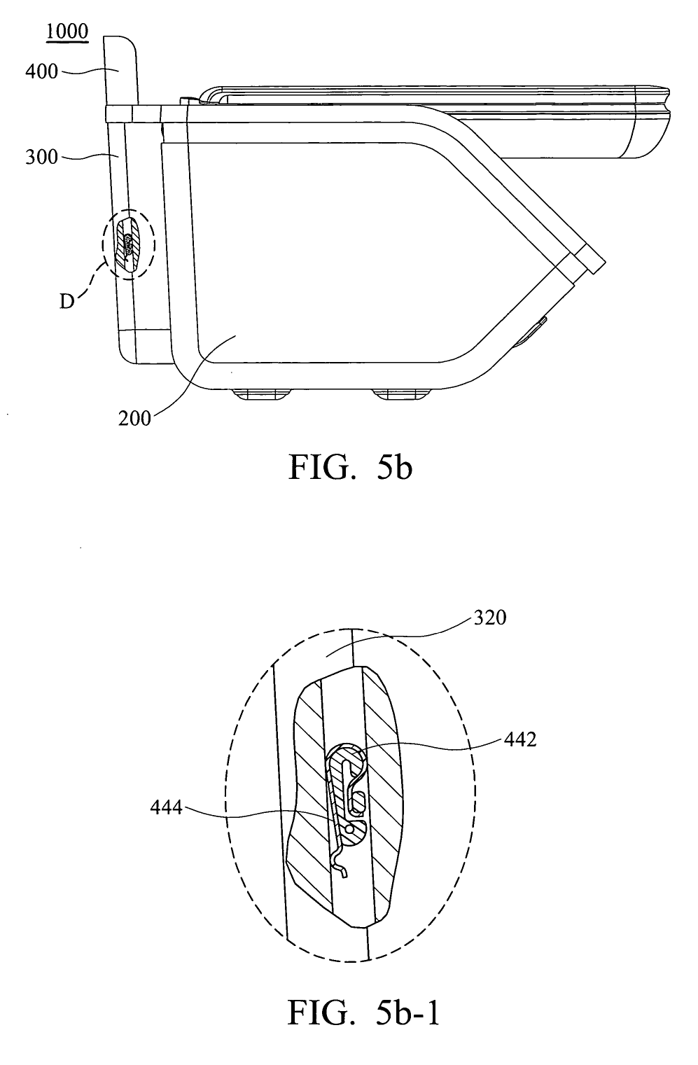

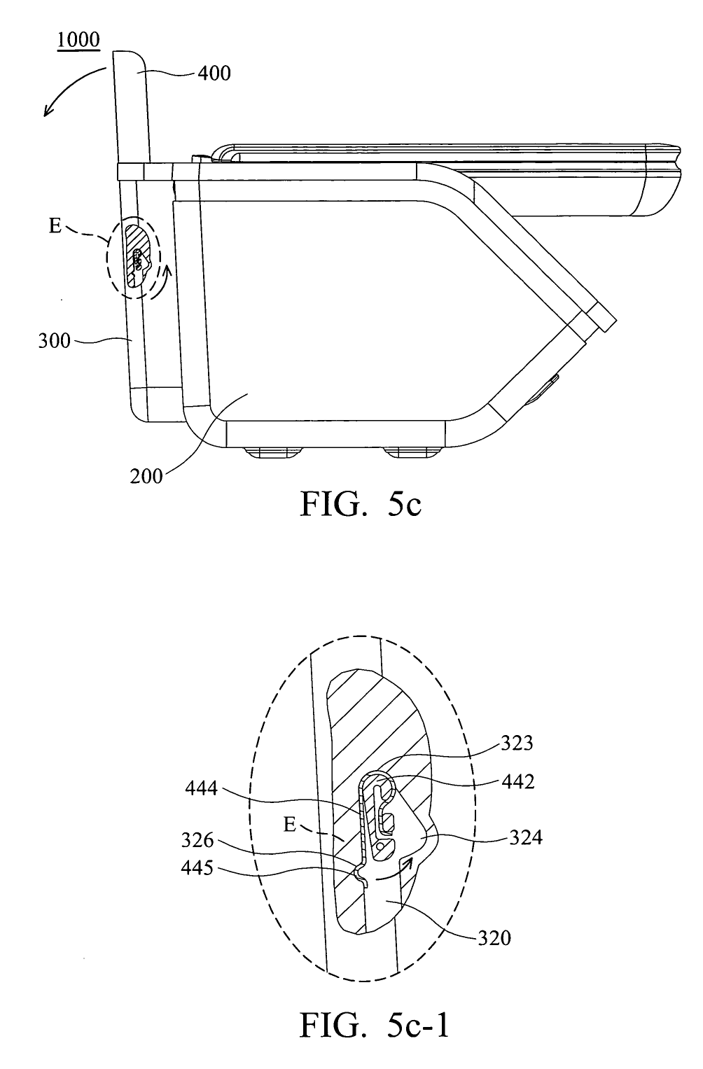

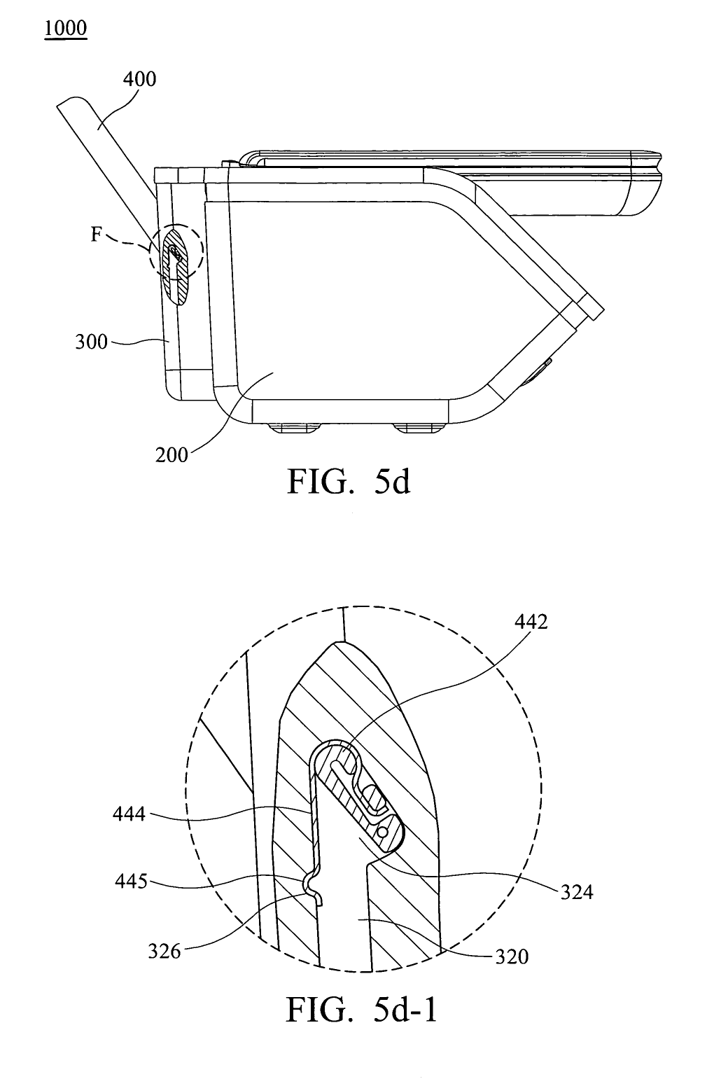

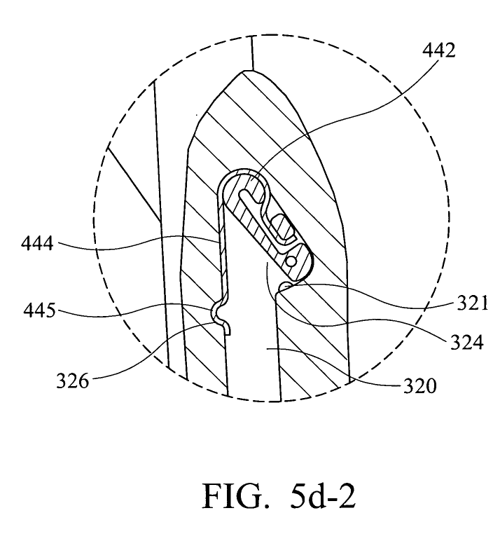

FIGS. 5a to 5d depict steps of tray 400 pulled from accommodating portion 300. Referring to FIGS. 5a and d5a-1, when the tray 400 is received in the accommodating portion 300, the convex portion 445 engages the second concave portion 328, whereby the tray 440 is positioned in a received position (second position).

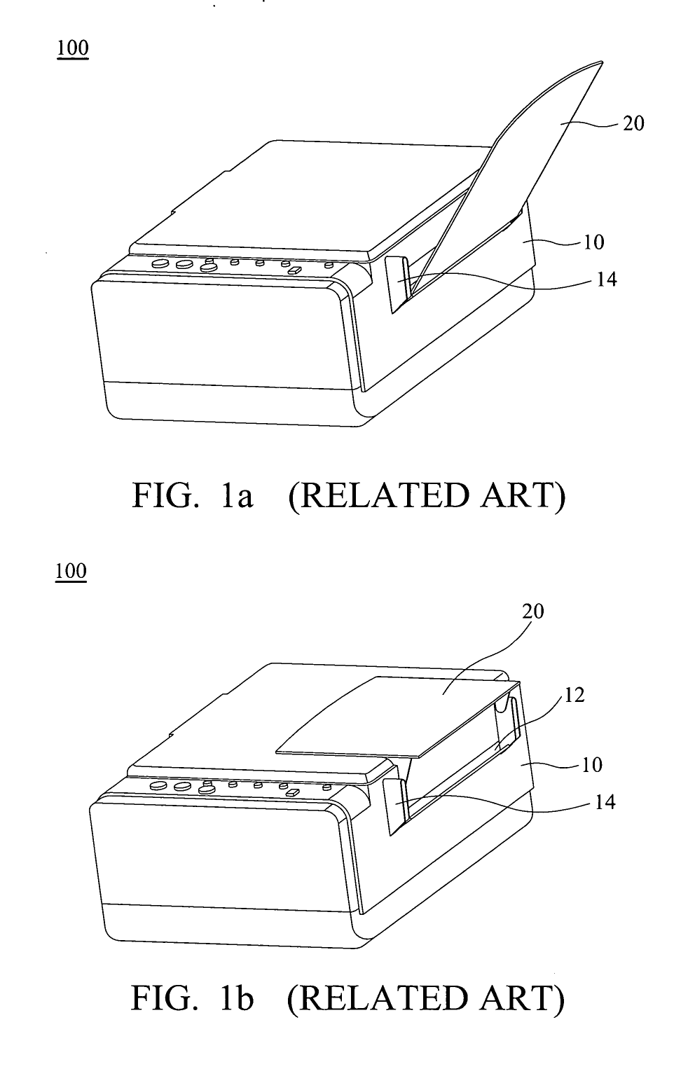

When the tray 400 is used, the tray 400 is pulled upward to overcome the spring force of the spring plate 444, whereby the convex portion 445 escapes from the second concave portion 328 and moves upward as shown in FIGS. 5b and 5b-1. The protrusion 442 maintains contact with the guide groove 320 due to the spring force of the spring plate 444.

When the tray 400 reaches the top of the guide groove 320 as shown in FIGS. 5c and 5c-1, the convex portion 445 engages the first concave portion 326, and the protrusion 442 contacts the arc portion 323 and is rotated counterclockwise therein due to spring force of the spring plate 444 to enter and abut the depression 324. The tray 400 is thereby positioned in a working position (first position) at an angle with respect to the main body 200 for loading paper as shown in FIGS. 5d and 5d-1. A stop element 321 is disposed in the depression 324, which prevents the pivot mechanism 440 from escaping from the depression 324 accidentally.

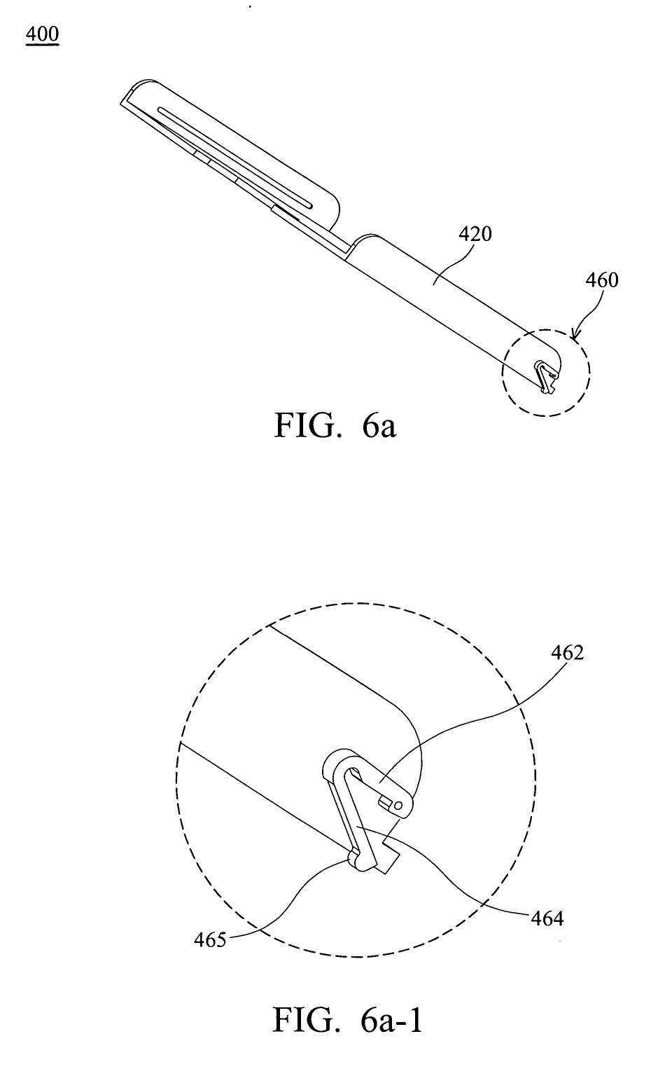

FIGS. 6a and 6b depict another embodiment of the pivot mechanism. The pivot mechanism 460 comprises a protrusion 462 and an elastic portion 464. The protrusion 462 is integrally formed with the elastic portion 464. The pivot mechanism 460 is substantially L-shaped. The protrusion 462 projects from one side of the tray 400. The elastic portion 464 has a convex portion 465 which can engage the first and second concave portions 326 and 328, whereby the tray 400 is positioned in the working and received position respectively.

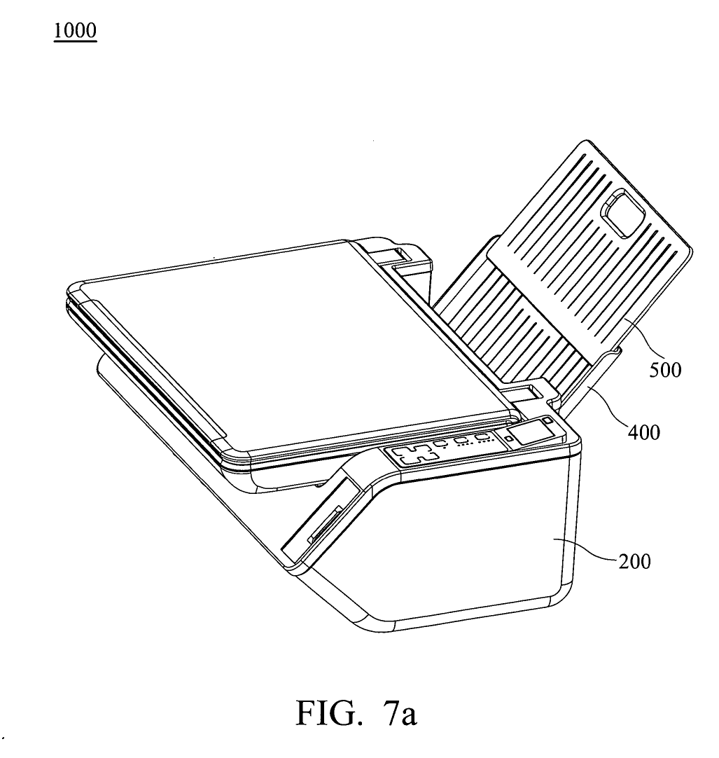

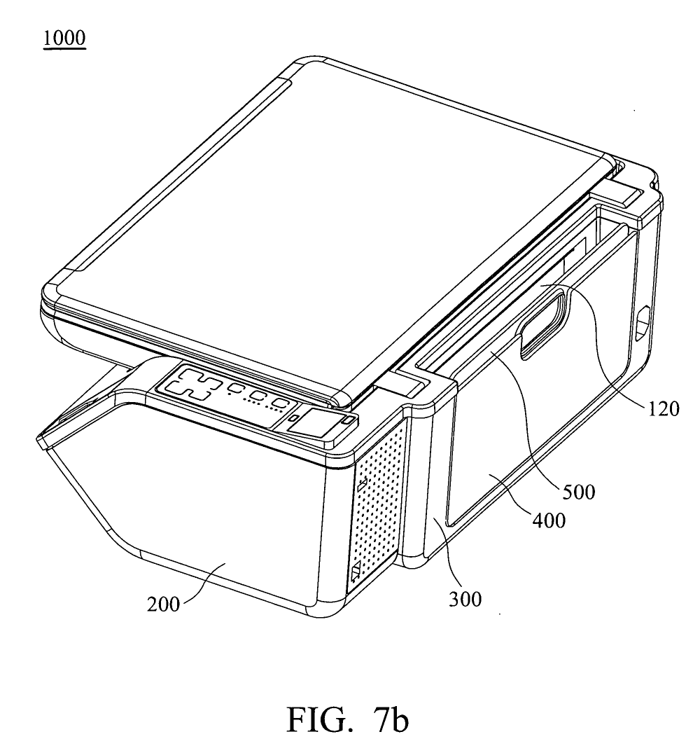

For loading paper of various sizes, a sub-tray 500 is added to the tray 400 as shown in FIGS. 7a and 7b. The sun-tray 500 can be pivoted to the tray 400, whereby the sun-tray 500 is rotated to lay on the tray 400 and is received with the tray 400 into the accommodating portion 300. In another aspect, the sub-tray 500 can slide on a groove formed on the tray 400 to extend out from the tray 400 or lay on the tray 400.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A business machine, comprising:
a main body having a paper feed slot;
an accommodating portion disposed around the paper feed slot and having a guide groove; and
a tray for loading paper slidably joined with the guide groove to be positioned in a first position and a second position, wherein when the tray is positioned in the first position, a predetermined angle is formed between the tray and the main body, and when the tray is in a second position, the tray is parallel to the guide groove and accommodated in the accommodating portion.

2. The business machine as claimed in claim 1, wherein the tray comprises a pivot mechanism slidably joined with the guide groove and positioned in the first and second positions by engaging the guide groove.

3. The business machine as claimed in claim 2, wherein the pivot mechanism comprises a protrusion slidably engaging the guide groove, the guide groove comprises a depression, and when the tray is positioned in the first position, the protrusion enters the depression to form the predetermined angle between the tray and the main body.

4. The business machine as claimed in claim 3, wherein the pivot mechanism further comprises an elastic element joined with the protrusion and having a convex portion, and the guide groove has a first concave portion and a second concave portion, and the tray is positioned in the first position when the convex portion engages the first concave portion and the tray is positioned in the second position when the convex portion engages the second concave portion.

5. The business machine as claimed in claim 4, wherein the elastic element is a spring plate which is substantially L-shaped with one end joining the protrusion and the other end having the convex portion.

6. The business machine as claimed in claim 5, wherein the protrusion projects in a direction perpendicular to the moving direction of the tray.

7. The business machine as claimed in claim 5, wherein the protrusion has a notch with which one end of the L-shaped spring plate engages.

8. The business machine as claimed in claim 3, wherein the protrusion comprises a protrusion and a elastic portion having a convex portion, and the guide groove has a first concave portion and a second concave portion, and the tray is positioned in the first position when the convex portion engages the first concave portion and the tray is positioned in the second position when the convex portion engages the second concave portion.

9. The business machine as claimed in claim 8, wherein the elastic portion is integrally formed with the protrusion.

10. The business machine as claimed in claim 8, wherein the protrusion is integrally formed with the tray.
